(19) United States
(12) Patent Application Publication
(10) Pub. No.: US 2015/0109887 A1
(43) Pub. Date: Apr. 23, 2015

(54) SONIC ADAPTOR FOR CONVERTING SONIC OR ULTRASONIC WAVEFORM DATA FOR USE WITH A SEISMIC-BASED COMPUTER PROGRAM

(71) Applicant: SCHLUMBERGER TECHNOLOGY CORPORATION, Sugar Land, TX (US)

(72) Inventors: Pradeep Jain, Sugar Land, TX (US); Jefferson Alford, Sugar Land, TX (US)

(21) Appl. No.: 14/517,258

(22) Filed: Oct. 17, 2014

Related U.S. Application Data
(60) Provisional application No. 61/892,780, filed on Oct. 18, 2013.

(51) Int. Cl. G01V 1/30; G01V 1/32

(52) U.S. Cl. CPC G01V 1/301; G01V 1/32
USPC 367/38

(57) ABSTRACT

A method, apparatus, and program convert waveform data, e.g., sonic or ultrasonic waveform data, to a seismic data format that is compatible with a seismic-based computer program such as a geology application, seismic application, attribute extraction application, visualization application, etc., thereby enabling the converted data to be analyzed using such a seismic-based computer program. By doing so, various attributes, analysis techniques, and visualization techniques, among others, that have traditionally been utilized for seismic data, may also be utilized for sonic and/or ultrasonic data.

### CROSS-REFERENCE TO RELATED APPLICATION

This application claims the benefit of U.S. Provisional Application No. 61/892,780 filed on Oct. 18, 2013 by Pradeep Jain and Jeff Alford, the entire disclosure of which is incorporated by reference herein in its entirety.

### BACKGROUND

Oilfield operations, such as surveying, drilling, wireline testing, completions, production, planning and oilfield analysis, may be performed to locate and gather valuable downhole hydrocarbons. During the oilfield operations, data may be collected for analysis and/or monitoring of the oilfield operations. Such data may include, for example, subterranean formation, equipment, historical and/or other data. Data concerning the subterranean formation is collected using a variety of sources, and may be static or dynamic. Static data relates to, for example, formation structure, and geological stratigraphy that define the geological structures of the subterranean formation. Dynamic data relates to, for example, fluids flowing through the geologic structures of the subterranean formation over time. Such static and/or dynamic data may be collected to learn more about the formations and the valuable assets contained therein.

Sources used to collect static data may be seismic tools, such as a seismic truck that sends compression waves into the earth. Signals from these waves are processed and interpreted to characterize changes in the elastic properties, such as velocity, density, or anisotropy of the geological formation at various depths. This information may be used to generate basic structural maps of the subterranean formation. Other static measurements may be gathered using downhole measurements, such as core sampling and well logging techniques. Core samples may be used to take physical specimens of the formation at various depths. Well logging involves deployment of a downhole tool into the wellbore to collect various downhole measurements, such as density, resistivity, etc., at various depths. Such well logging may be performed using, for example, a drilling pipe conveyed tool during drilling operations, or afterwards, casing conveyed tool, and/or a wireline tool. Once the well is formed and completed, fluid flows to the surface using production tubing and other completion equipment. As fluid passes to the surface, various dynamic measurements, such as fluid flow rates, pressure, and composition may be monitored. These parameters may be used to determine various characteristics of the subterranean formation.

Sensors may be positioned about an oilfield to collect data relating to various oilfield operations. For example, sensors in the drilling equipment may monitor drilling conditions, sensors in the wellbore may monitor fluid composition, sensors located along the flow path may monitor flow rates, and sensors at the processing facility may monitor fluids collected. Other sensors may be provided to monitor downhole, surface, equipment or other conditions. Such conditions may relate to the type of equipment at the wellsite, the operating setup, formation parameters, or other variables of the oilfield. The monitored data is often used to make decisions at various locations of the oilfield at various times. Data collected by these sensors may be further analyzed and processed. Data may be collected and used for current or future operations. When used for future operations at the same or other locations, such data may sometimes be referred to as historical data.

The data may be used to predict downhole conditions, and make decisions concerning oilfield operations. Such decisions may involve well planning, well targeting, well completions, operating levels, production rates and other operations and/or operating parameters. Often this information is used to determine when to drill new wells, re-complete existing wells, or alter wellbore production. Oilfield conditions, such as geological, geophysical and reservoir engineering characteristics may have an impact on oilfield operations, such as risk analysis, economic valuation, and mechanical considerations for the production of subsurface reservoirs.

Data from one or more wellbores may also be analyzed to plan or predict various outcomes at a given wellbore. In some cases, the data from neighboring wellbores or wellbores with similar conditions or equipment may be used to predict how a well will perform. Generally, a large number of variables and large quantities of data may be used to consider in analyzing oilfield operations. It is, therefore, often useful to model the behavior of the oilfield operation to determine the desired course of action. During the ongoing operations, the operating conditions may need adjustment as conditions change and new information is received.

Techniques have been developed to model the behavior of various aspects of the oilfield operations, such as geological structures, downhole reservoirs, wellbores, surface facilities as well as other portions of the oilfield operation. There are different types of simulators for different purposes. For example, there are simulators that focus on reservoir properties, wellbore production, or surface processing. Furthermore, attempts have been made to consider a broader range of data in oilfield operations and couple together different types of simulators.

Despite these advancements, challenges still exist. For example, seismic surveys have long been a source of data for use in characterizing and analyzing reservoirs, and as a result, numerous tools and techniques have been developed to store, process and visualize reservoir characteristics based upon seismic data. For many reservoir simulators, seismic data is organized into seismic volumes, such as seismic cubes, representing various characteristics or attributes in a given subsurface volume. Seismic surveys are conducted by sending low frequency (e.g., between about 1-100 Hz) seismic waves into the Earth and measuring the returning energy with a series of geophone receivers disposed at known locations relative to the source. When seismic energy encounters an interface between two materials with different acoustic impedance, a portion of the energy reflects off of the interface, and thus the measured seismic signals may be used to detect the locations of such interfaces. Other characteristics of the seismic data, including refractions, travel times, and phase transitions, may also be extracted from the seismic data.

By processing such data in known manners, a wealth of information about a reservoir can be ascertained, including numerous attributes that characterize a reservoir. Furthermore, numerous visualization tools have been developed to facilitate interpretation of seismic data and identification of potential pay zones in a reservoir.

Another technique for use in characterizing subsurface formations is sonic or acoustic logging, which relies on a tool that is positioned in a wellbore and that emits a relatively higher frequency sonic signal (e.g., about 300 Hz-20 kHz or higher) that only penetrates a short distance into the surrounding formation. A sonic logging tool performs measurements along the length of the wellbore, and may be coupled to a bottom hole assembly (BHA) to generate sonic logs while drilling. Compared to seismic data, the sonic data collected via sonic logging is a substantially higher resolution (e.g., inches vs. meters) but may be limited in radial investigation depth to those areas in close proximity to a wellbore.

Sonic logs have traditionally been used to calculate porosity of a formation around a wellbore; however, the amount of processing that is performed with sonic logs has generally been limited to attenuation and primary (p), secondary (s) and Stoneley wave velocity information. As compared to seismic data, the types of techniques and tools available to process and extract useful information for characterizing a reservoir from sonic data is substantially more limited.

Ultrasonic logging, e.g., utilizing ultrasonic signals above about 20 kHz, is another technique that likewise is limited in terms of available techniques and tools as compared to seismic.

Therefore, a substantial need continues to exist in the art for an improved manner of processing and utilizing sonic or ultrasonic data, particularly in an oil & gas environment.

### SUMMARY

The embodiments disclosed herein provide a method, apparatus, and program product that convert waveform data, e.g., sonic or ultrasonic waveform data, to a seismic data format that is compatible with a seismic-based computer program such as a geology application, seismic application, attribute extraction application, visualization application, etc., thereby enabling the converted data to be analyzed using such a seismic-based computer program. By doing so, various attributes, analysis techniques, and visualization techniques, among others, that have traditionally been utilized for seismic data, may also be utilized for sonic and/or ultrasonic data.

Therefore, consistent with one aspect of the invention, sonic or ultrasonic waveform data may be analyzed by converting waveform data in a sonic or ultrasonic frequency range to a seismic data format, and analyzing the waveform data using a seismic-based computer program executing on at least one processor after converting the waveform data to the seismic data format.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a block diagram of an example hardware and software environment for a data processing system in accordance with implementation of various technologies and techniques described herein.

FIGS. 2A-2D illustrate simplified, schematic views of an oilfield having subterranean formations containing reservoirs therein in accordance with implementations of various technologies and techniques described herein.

FIG. 3 illustrates a schematic view, partially in cross section of an oilfield having a plurality of data acquisition tools positioned at various locations along the oilfield for collecting data from the subterranean formations in accordance with implementations of various technologies and techniques described herein.

FIG. 4 illustrates a production system for performing one or more oilfield operations in accordance with implementations of various technologies and techniques described herein.

FIG. 5 is a block diagram illustrating a seismic-based data analysis system incorporating a sonic adapter consistent with the invention.

FIG. 6 is a block diagram illustrating the integration of sonic data into a seismic-based data analysis system in a manner consistent with the invention.

FIG. 7 is a diagram of an example user interface for the sonic adapter of FIG. 6.

FIG. 8 is a diagram illustrating an example arrangement of sonic data in a seismic volume.

FIG. 9 is a flowchart illustrating a sequence of operations for converting sonic data to a seismic data format in a manner consistent with the invention.

FIG. 10 is a diagram illustrating an example set of sonic waveforms collected from a sonic tool disposed in a wellbore in connection with an example project logging run.

FIG. 11 is a diagram illustrating the collection of multiple sets of sonic waveforms at multiple depths along the wellbore of FIG. 10.

FIG. 12 is a diagram illustrating example rotation and time data scale adjustment operations performed on the set of waveforms of FIG. 10.

FIG. 13 is a diagram illustrating an example basemap generated for the project logging run of FIGS. 10-12.

FIG. 14 is a diagram of an example visualization using a two dimensional seismic interpretation application and including the basemap of FIG. 13.

FIGS. 15 and 16 are diagrams illustrating example visualizations of sonic data using a seismic-based visualization application.

FIG. 17 is a diagram illustrating an example visualization of sonic data in a seismic mapping application.

FIG. 18 is a diagram illustrating an example visualization of sonic data in a three dimensional seismic application.

FIG. 19 is a diagram illustrating an example visualization of sonic data in a geology application.

FIGS. 20 and 21 are diagrams illustrating an example attribute extraction operations performed on sonic data in an seismic-based attribute extraction application.

### DETAILED DESCRIPTION

The herein-described embodiments invention provide a method, apparatus, and program product that convert sonic or ultrasonic data from a sonic or ultrasonic data format to a seismic data format to facilitate analysis and/or visualization of the converted sonic data by a seismic-based computer program. In addition, in some embodiments, converted sonic or ultrasonic data may be converted back from the seismic domain to the sonic or ultrasonic domain for further analysis or presentation using a sonic or ultrasonic-based computer program. By converting the waveform data into a seismic data format, the waveform data effectively masquerades as seismic data from the perspective of a seismic-based computer program, thereby enabling the waveform data to be processed, visualized, and analyzed in effectively the same manner as actual seismic data.

A seismic-based computer program, in this regard, may include any application, tool or other program code that normally processes seismic data stored in a seismic data format, while a seismic data format is a format for storing seismic data and that is readable by a seismic-based application, e.g., the SEG-Y data format, or other data formats such as vvol, zgy, and other disk based file structures. The seismic data format may arrange seismic data in a volume such as a seismic cube in some embodiments.

Seismic data is generally data collected via a seismic survey, and generally relates to seismic waves having a frequency of less than about 100 Hz, and generally has a resolution in meters. Seismic data may be multi-axis in nature, e.g., two or three dimensional, and seismic volumes may be sliced into two dimensional slices for analysis and attribute extraction in some embodiments.

Sonic data, in contrast, is generally collected via logging in a wellbore, and is based on sonic or acoustical waves having a frequency of about 300 Hz to about 100 kHz in many embodiments. Sonic data may also be collected in some embodiments from permanent sensors installed in a wellbore to monitor ongoing production. Sonic data in some embodiments may be oriented radially, axially or laterally about a wellbore, and may be formatted in a data format such as DLIS (Digital Log Interchange Standard). Ultrasonic data is generally collected in a similar manner, albeit based on higher frequency waves having a frequency of greater than about 50 kHz. Both sonic and ultrasonic data have a higher resolution than seismic data, although the collected data is generally centered around a wellbore and projecting only a few inches or feet into the surrounding rock.

Examples of seismic-based computer programs include, but are not limited to, computer programs such as attribute extraction tools that extract various types of attributes from seismic data, e.g., attributes such as root mean square seismic amplitude, half energy, average magnitude, maximum magnitude, instantaneous frequency, instantaneous phase, maximum amplitude, minimum amplitude, mean amplitude, average peak value, average peak value (zero X), average trough value, average trough value (zero X), reflection magnitude (envelope), ration of positive to negative, arc length, threshold value, average energy, dominant frequency, bandwidth, bandwidth rating (bias or debias), sum of amplitudes, sum of positive amplitudes, sum of negative amplitudes, sum of magnitudes, window length, blip horizon, curvature, spectral decomposition, etc., or any other attributes commonly extracted from seismic data. One available attribute extraction tool, for example, is the Seismic Attribute Toolkit (SATK) tool available from Schlumberger Ltd., although other attribute extraction tools, e.g., the Geophysics Volume and Surface attributes modules in the Petrel environment available from Schlumberger Ltd., may be used in the alternative.

Seismic-based computer programs may also include visualization tools usable for interpreting and visualizing seismic data, as well as tools suitable for mapping, desnoising, interpolating and performing various math operations on seismic data. An example visualization tool is the IESX visualization module in the GeoFrame integrated reservoir characterization system available from Schlumberger Ltd.

Seismic-based computer programs may also include additional geology applications, the GeoViz 3D seismic application, the Basemap mapping application, the Mathcube seismic calculator, and other seismic modules in the aforementioned Petrel and Omega applications, all available from Schlumberger Ltd. Other seismic-based computer programs will be apparent to one of ordinary skill in the art having the benefit of the instant disclosure.

Therefore, in some embodiments of the invention, sonic or ultrasonic waveform data may be analyzed by converting waveform data in a sonic or ultrasonic frequency range to a seismic data format, and analyzing the waveform data using a seismic-based computer program executing on at least one processor after converting the waveform data to the seismic data format.

In some embodiments, the seismic-based computer program includes a seismic application, and analyzing the waveform data includes processing the waveform data using the seismic application to generate result data. In some embodiments, the result data may also be converted from a seismic data format to a sonic data format, and in some embodiments, the result data may be processed using a sonic-based computer program after converting the result data to the sonic data format.

In some embodiments, the waveform data may be converted from a sonic data format, and the waveform data may be processed using a sonic-based computer program prior to converting the waveform data to the seismic data format. In some embodiments, processing the waveform data using the sonic-based computer program includes extracting time of arrival data from the waveform data and storing the time of arrival data in a set of logs. In addition, in some embodiments, the time of arrival data may be refined using the seismic-based computer program.

In some embodiments, converting the waveform data may include organizing the waveform data into at least one seismic volume, and in some embodiments, the seismic volume includes a seismic cube or a pseudo-seismic cube. In addition, in some embodiments, the seismic-based computer program includes an attribute extraction tool, and analyzing the waveform data includes extracting at least one seismic attribute from the at least one seismic volume using the attribute extraction tool.

In some embodiments, converting the waveform data includes rotating the waveform data prior to storing the waveform data in the seismic data format, and in some embodiments, converting the waveform data further includes adjusting a time scale of the waveform data prior to storing the waveform data in the seismic data format.

In some embodiments, the waveform data includes sonic waveform data in a sonic frequency range and collected via sonic logging, and in some embodiments, the waveform data includes ultrasonic waveform data in an ultrasonic frequency range and collected via ultrasonic logging. In additional embodiments, the waveform data is collected via wellbore logging, and the seismic-based computer program is configured to operate on seismic data collected via a surface seismic survey, while in other embodiments, the seismic-based computer program includes a visualization tool, and analyzing the waveform data includes displaying the waveform data using the visualization tool. In still other embodiments, converting the waveform data to the seismic data format masquerades the waveform data as seismic data.

Some embodiments may also include an apparatus including at least one processor and program code configured upon execution by the at least one processor to receive waveform data in a sonic or ultrasonic frequency range and convert the waveform data to a seismic data format such that the converted waveform data is in a format that is compatible with a seismic-based computer program after converting the waveform data to the seismic data format. Some embodiments may also include a program product including a computer readable medium and program code stored on the computer readable medium and configured upon execution by at least one processor to receive waveform data in a sonic or ultrasonic frequency range and convert the waveform data to a seismic data format such that the converted waveform data is in a format that is compatible with a seismic-based computer program after converting the waveform data to the seismic data format.

Other variations and modifications will be apparent to one of ordinary skill in the art.

### Hardware and Software Environment

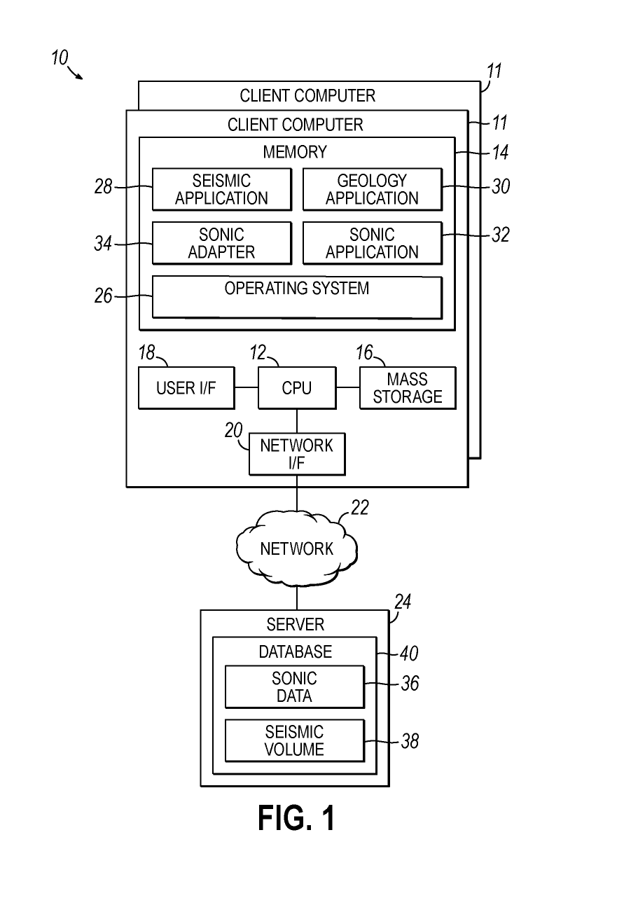

Turning now to the drawings, wherein like numbers denote like parts throughout the several views, FIG. 1 illustrates an example data processing system 10 in which the various technologies and techniques described herein may be implemented. System 10 is illustrated as including one or more computers 11, e.g., client computers, each including a central processing unit 12 including at least one hardware-based microprocessor coupled to a memory 14, which may represent the random access memory (RAM) devices comprising the main storage of a computer 11, as well as any supplemental levels of memory, e.g., cache memories, non-volatile or backup memories (e.g., programmable or flash memories), read-only memories, etc. In addition, memory 14 may be considered to include memory storage physically located elsewhere in a computer 11, e.g., any cache memory in a microprocessor, as well as any storage capacity used as a virtual memory, e.g., as stored on a mass storage device 16 or on another computer coupled to a computer 11.

Each computer 11 also generally receives a number of inputs and outputs for communicating information externally. For interface with a user or operator, a computer 11 generally includes a user interface 18 incorporating one or more user input devices, e.g., a keyboard, a pointing device, a display, a printer, etc. Otherwise, user input may be received, e.g., over a network interface 20 coupled to a network 22, from one or more servers 24. A computer 11 also may be in communication with one or more mass storage devices 16, which may be, for example, internal hard disk storage devices, external hard disk storage devices, storage area network devices, etc.

A computer 11 generally operates under the control of an operating system 26 and executes or otherwise relies upon various computer software applications, components, programs, objects, modules, data structures, etc. For example, a computer may utilize one or more petro-technical applications such as a seismic application 28, geology application 30 and sonic application 32, and a sonic adapter 34, described in greater detail below, may be used to convert between sonic and seismic domains, e.g., for between sonic data 36 and one or more seismic volumes 38 stored in a database 40. The invention, however, is not limited to the particular client/server architecture disclosed herein, or to the particular applications illustrated in FIG. 1.

In general, the routines executed to implement the embodiments disclosed herein, whether implemented as part of an operating system or a specific application, component, program, object, module or sequence of instructions, or even a subset thereof, will be referred to herein as “computer program code,” or simply “program code.” Program code generally comprises one or more instructions that are resident at various times in various memory and storage devices in a computer, and that, when read and executed by one or more processors in a computer, cause that computer to perform the steps embodying desired functionality. Moreover, while embodiments have and hereinafter will be described in the context of fully functioning computers and computer systems, those skilled in the art will appreciate that the various embodiments are capable of being distributed as a program product in a variety of forms, and that the invention applies equally regardless of the particular type of computer readable media used to actually carry out the distribution.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, DVD, or other optical storage, magnetic cassettes, magnetic tape, magnetic disk storage or other magnetic storage devices, or any other medium that can be used to store the desired information and which can be accessed by computer 10. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

Various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the example environment illustrated in FIG. 1 is not intended to limit the invention. Indeed, those skilled in the art will recognize that other alternative hardware and/or software environments may be used without departing from the scope of the invention.

### Oilfield Operations

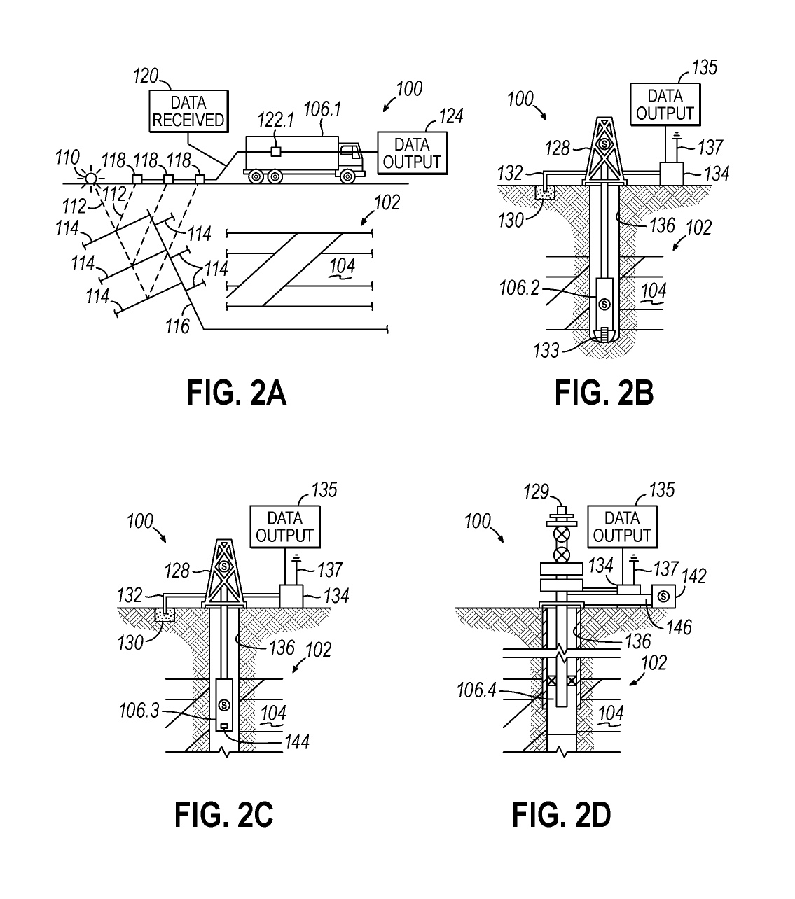

FIGS. 2a-2d illustrate simplified, schematic views of an oilfield 100 having subterranean formation 102 containing reservoir 104 therein in accordance with implementations of various technologies and techniques described herein. FIG. 2a illustrates a survey operation being performed by a survey tool, such as seismic truck 106.1, to measure properties of the subterranean formation. The survey operation is a seismic survey operation for producing sound vibrations. In FIG. 2a, one such sound vibration, sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 2b illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud may be filtered and returned to the mud pit. A circulating system may be used for storing, controlling, or filtering the flowing drilling muds. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produces data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Generally, the wellbore is drilled according to a drilling plan that is established prior to drilling. The drilling plan sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 2c illustrates a wireline operation being performed by wireline tool 106.3 suspended by rig 128 and into wellbore 136 of FIG. 2b. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 2a. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 2d illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 2b-2d illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 2a-2d are intended to provide a brief description of an example of a field usable with oilfield application frameworks. Part, or all, of oilfield 100 may be on land, water, and/or sea. Also, while a single field measured at a single location is depicted, oilfield applications may be utilized with any combination of one or more oilfields, one or more processing facilities and one or more wellsites.

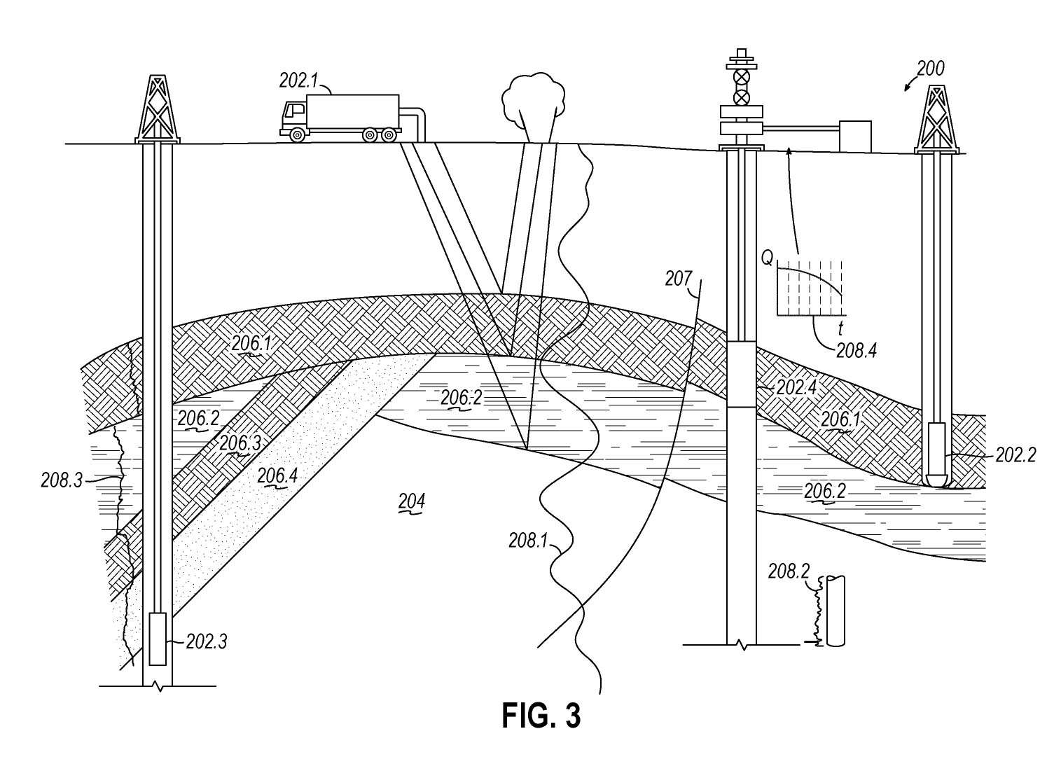

FIG. 3 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 2a-2d, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that generally provides a resistivity or other measurement of the formation at various depths.

A production decline curve or graph 208.4 is a dynamic data plot of the fluid flow rate over time. The production decline curve generally provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, generally below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 3, may then be processed and/or evaluated. Generally, seismic data displayed in static data plot 208.1 from data acquisition tool 202.1 is used by a geophysicist to determine characteristics of the subterranean formations and features. The core data shown in static plot 208.2 and/or log data from well log 208.3 are generally used by a geologist to determine various characteristics of the subterranean formation. The production data from graph 208.4 is generally used by the reservoir engineer to determine fluid flow reservoir characteristics. The data analyzed by the geologist, geophysicist and the reservoir engineer may be analyzed using modeling techniques.

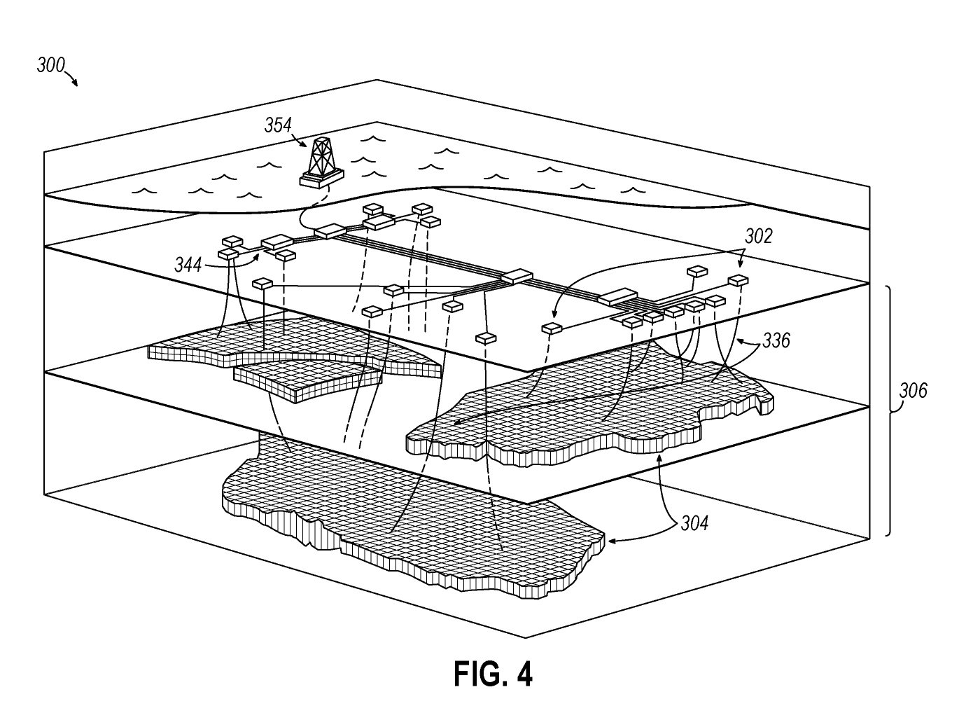

FIG. 4 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 4 is not intended to limit the scope of the oilfield application system. Part or all of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

### Sonic Adapter

Embodiments consistent with the invention may be used to convert sonic or ultrasonic data, e.g., waveform data, to a seismic data format, e.g., based upon seismic volumes, enabling various seismic-based computer programs to be used to process, analyze, interpret, or visualize the sonic or ultrasonic data. In addition, in some embodiments, result data generated using a seismic-based computer program may be converted back from the seismic domain to a sonic or ultrasonic domain for further analysis and presentations.

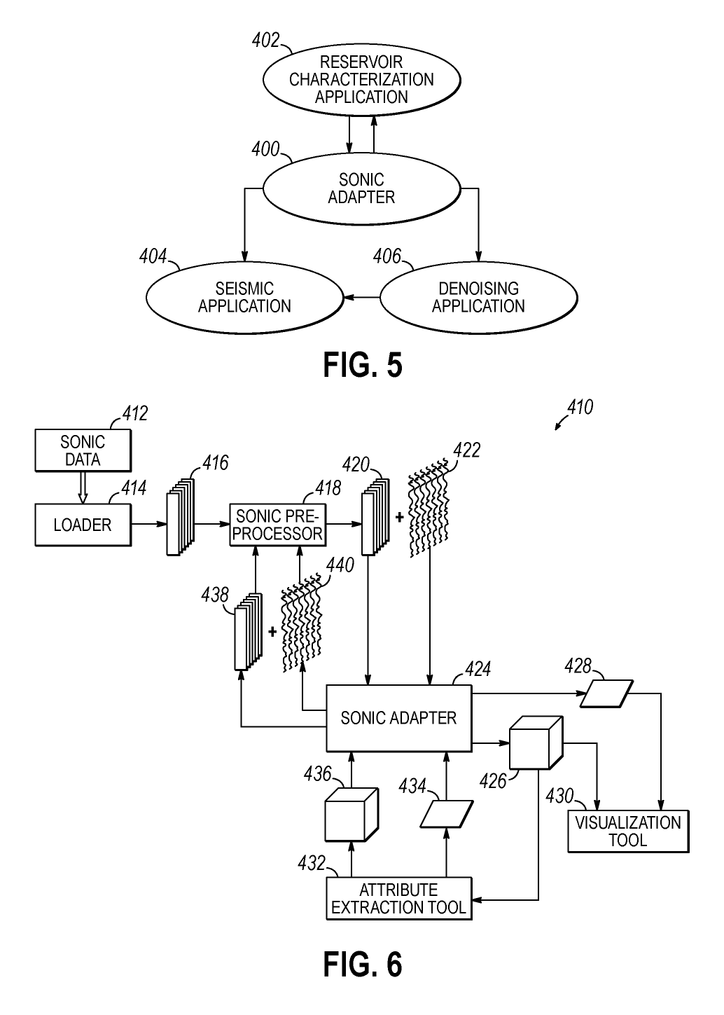

FIG. 5, for example, illustrates an example seismic-based data analysis system incorporating a sonic adapter tool 400 suitable for converting sonic or ultrasonic data to a seismic data format for processing by one or more seismic-based computer programs, e.g., a reservoir characterization application or system 402 such as the GeoFrame environment, a seismic application 404 such as a visualization tool or attribute extraction tool, e.g., the aforementioned SATK and IESX tools, and a denoising and/or interpolation application 406 such as the Omega seismic processing system available from Schlumberger Ltd.

FIG. 6 illustrates the integration of sonic data into a seismic-based data analysis system 410 in one example embodiment. In this embodiment, sonic waveform data 412, e.g., sonic waveform data formatted in a DLIS format, may be loaded into a sonic-based application (e.g., a GeoFrame interpretation system) using a loader component 414. The sonic waveform data may represent a set of waveforms 416, and may be initially processed by a sonic pre-processor tool 418 such as the BestDT tool available from Schlumberger Ltd. Tool 418 processes waveform data 416 and outputs a set of refined waveforms 420 along with a set of logs 422 including, for example, times of arrival or times of first arrival.

The sonic data may be collected in a number of different manners known in the art, e.g., using various types of sonic logging tool such as monopole logging tools, dipole logging tools, quadropole logging tools, octopole logging tools, etc. The sonic data may be collected and conveyed via wireline, via logging while drilling (LWD), via pipe conveyed wirelines (PCW), etc. and stored for later processing. The sonic data may be symmetric, azimuthal, or asymmetric based upon the logging tool, and may be oriented laterally, axially and/or radially relative to a wellbore.

The waveform collection including refined waveforms 420 and logs 422 is sent to a sonic adapter tool 424, which converts the data into a seismic data format, e.g., into one or more sonic volumes or cubes 426. The adapter may also convert logs 422 into a grid 428 to facilitate synchronized viewing and processing of the waveforms and the logs by a seismic-based tool, e.g., a visualization tool 430. Visualization tool 430 may also be used to visualize the data in seismic volume 426 for interpretation and other analysis. Various applications or tools, including geology and other seismic-based applications, may also process the data in this format, and in some embodiments, the analysis may be in conjunction with additional petrophysical data.

In addition, an attribute extraction tool 432 may be used to extract one or more seismic attributes 434, and may result in the generation of other seismic volumes 436 and/or grids for horizon attribute extractions. The extracted data may also be converted by sonic adapter 424 back to the sonic domain from the seismic domain, e.g., by converting the seismic volumes back to sonic waveforms 438 and converting grids back into logs 440 for access by sonic-based computer programs such as the sonic pre-processor tool 418. It will be appreciated that the inverse of the transformations performed when converting sonic data to the seismic domain (e.g., rotating the data and/or adjusting a scale) may be performed when converting back to the sonic domain.

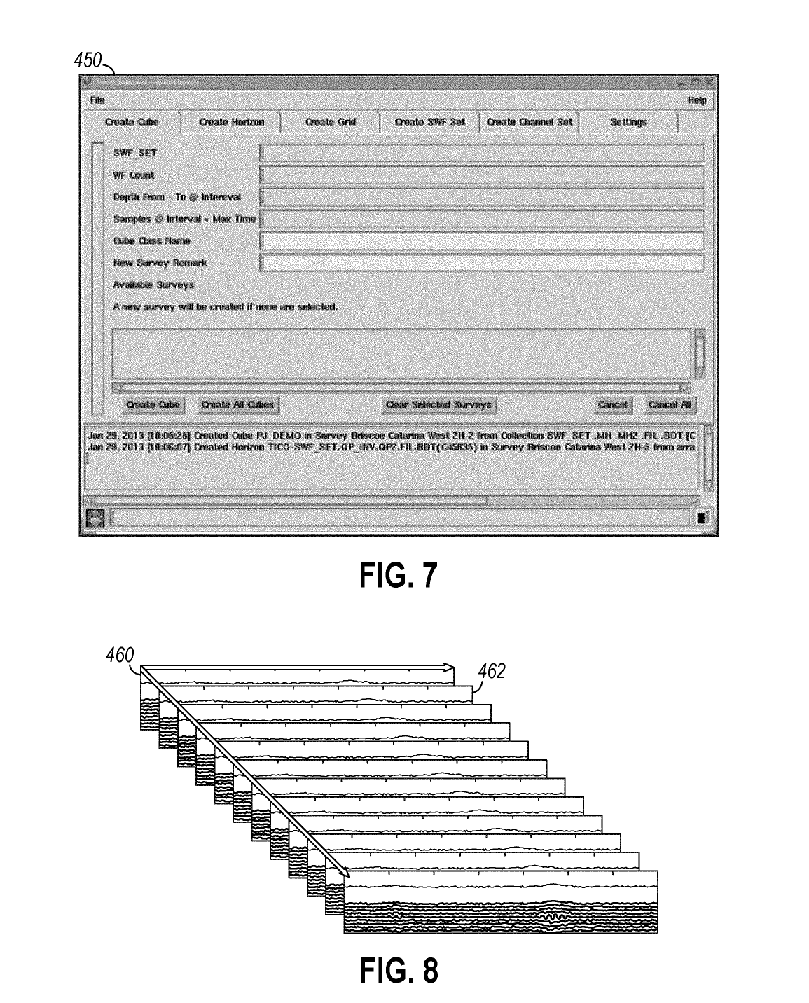

It will be appreciated that the conversion of sonic waveform data from a sonic data format to a seismic data format, and into a seismic volume such as a seismic cube, as well as the complementary operation of converting back to a sonic data format, would be well within the abilities of one of ordinary skill in the art having the benefit of the instant disclosure. For example, as illustrated by window 450 of FIG. 7, sonic adapter 424 may include workflows for creating a seismic volume (cube), create a horizon, create a grid, create a sonic waveform (SWF) set, and create a channel set. To create a seismic volume, for example, a user may input a sonic waveform set (SWF_SET), a waveform count, a depth from—to at an interval (e.g., specified in settings), a number of samples at the specified interval, a class name for the volume, and any desired remarks. Based upon this information, the sonic waveform data may be packed into a seismic volume, e.g., as illustrated in FIG. 8, where a set 460 of sonic waveforms 462 taken by a plurality of receivers at a particular depth along a borehole are packed into a seismic volume (here a cube). The resulting seismic volume formed from the sonic data may be referred to herein as a pseudo-seismic cube or volume in some embodiments.

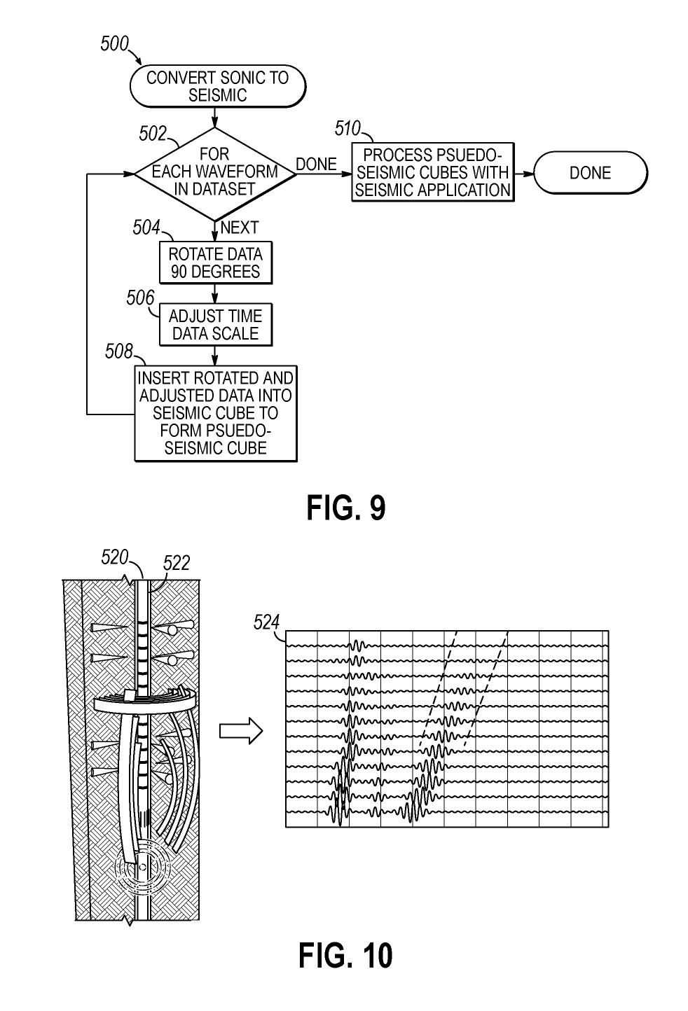

FIG. 9 next illustrates an example routine 500 that may be performed by sonic adapter 424 to convert sonic data into a seismic data format in a manner consistent with the invention. For example, as illustrated in FIG. 10, sonic data may be collected by a sonic tool 520 disposed in a wellbore 522. Sonic tool 520 may be, for example, a Sonic Scanner acoustic scanning platform available from Schlumberger Ltd., including a sonic source and a 12 receiver configuration, and configured to azimuthally record 12 receiver waveform arrays in response to transmissions from one or more sonic sources in the tool. A set of 12 waveforms collected in response to a single reading are illustrated at 524, where the vertical (Y) axis distinguishes the 12 waveforms, and the horizontal (X) axis represents time (e.g., in microseconds).

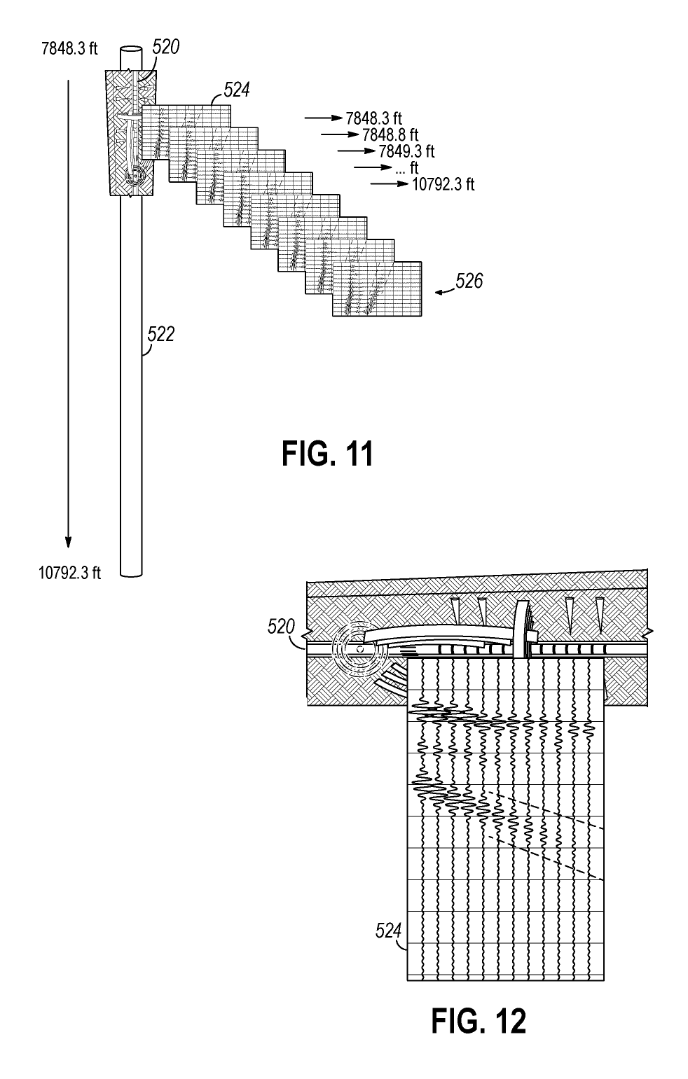

In this example, and as further illustrated in FIG. 11, a project logging run is assumed to be run in wellbore 522 between the depths of 7848.3 and 10792.3 feet, with waveforms recorded every six inches. As a result, a collection 526 of waveform sets 524 may be generated to constitute the input dataset of sonic data collected during the project logging run.

Returning routine 500 of FIG. 9, for each waveform of an input dataset of sonic data, block 502 passes control to block 504 to rotate the waveform data 90 degrees. In addition, block 506 adjusts the time data scale, e.g., so that the waveforms are compatible with the types of waveforms expected by seismic applications. In particular, seismic waveforms are generally measured in units of milliseconds, whereas sonic waveforms are generally recorded at a higher resolution, such that the waveforms may be measured, for example, in units of microseconds. Adjusting the time data scale therefore may include multiplying time data for the waveforms by a factor of 10 such that a sonic waveform that is recorded in units of microseconds is effectively “stretched” to appear as a seismic waveform recorded in units of milliseconds.

It will be appreciated that adjusting of the time scale may not be performed in some embodiments, e.g., if a seismic application is capable of working on a microsecond scale. Other adjustments of time data scale (e.g., stretching by a factor other than 10) may also be used in other embodiments.

By rotating and adjusting the time data scale of each waveform, a pseudo-seismic survey may be created with an array of cross lines corresponding to a waveform array, and with each in line corresponding to depth (e.g., in a wellbore) at which a waveform was collected. For example, as illustrated diagrammatically in FIG. 12, rotating the waveform 90 degrees orients the data in a similar manner to seismic lines. Consequently, routine 500 may effectively generate a pseudo-seismic survey of 12×6132 (where 12 is the number of cross lines/waveform arrays and 6132 is the number of in lines that may be used to span the depth range between 7,848.3 and 10,792.3 feet).

Returning to routine 500 of FIG. 9, once the data is rotated and the time data scale is adjusted, block 508 inserts the rotated and time adjusted data into a seismic cube (also referred to as a “pseudo seismic cube” given that the data is actually sonic data) and stores the seismic cube in a data format suitable for use by seismic applications, e.g., SEG-Y, vvol, zgy, or another suitable seismic data format. Control then passes to block 502 to process additional waveforms in the sonic dataset. Once each waveform has been processed, control passes from block 502 to block 510 to process the stored pseudo-seismic cubes with a seismic application, in any of the various manners and/or for the various purposes described herein. Routine 500 is then complete.

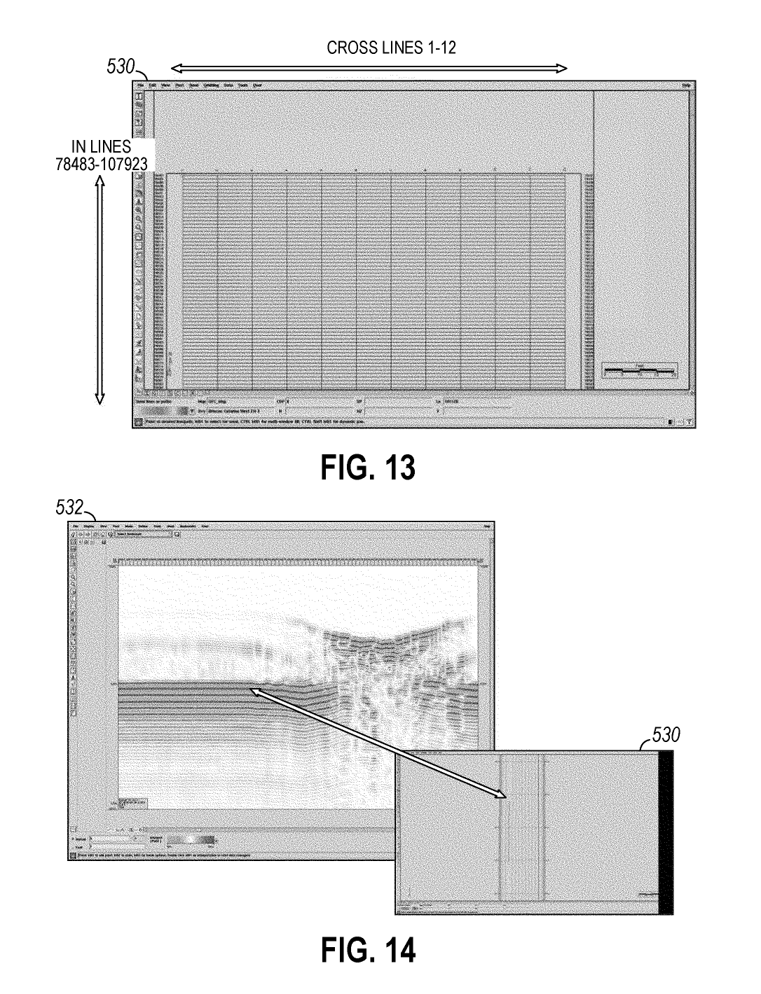

Turning to FIG. 13, for example, an example basemap 530 is illustrated for the dataset described above in connection with FIGS. 10-12, whereby 12 cross lines are illustrated in the horizontal (X) axis, and 6192 in lines are illustrated in the vertical (Y) axis representing a depth range of 7848.3 to 10,792.3 feet corresponding to the depth range along the wellbore for the example logging run. FIG. 13 additionally illustrates basemap 530 in a zoomed-in view, as well as a data visualization 532 represented by the zoomed-in portion of the basemap 530. In particular, data visualization 532 is of sonic traces along the borehole for a particular receiver, having a horizontal (X) axis corresponding to wellbore depth for the logging run, a vertical (Y) axis representing time adjusted traces, and viewed in a Variable Intensity (VI) mode.

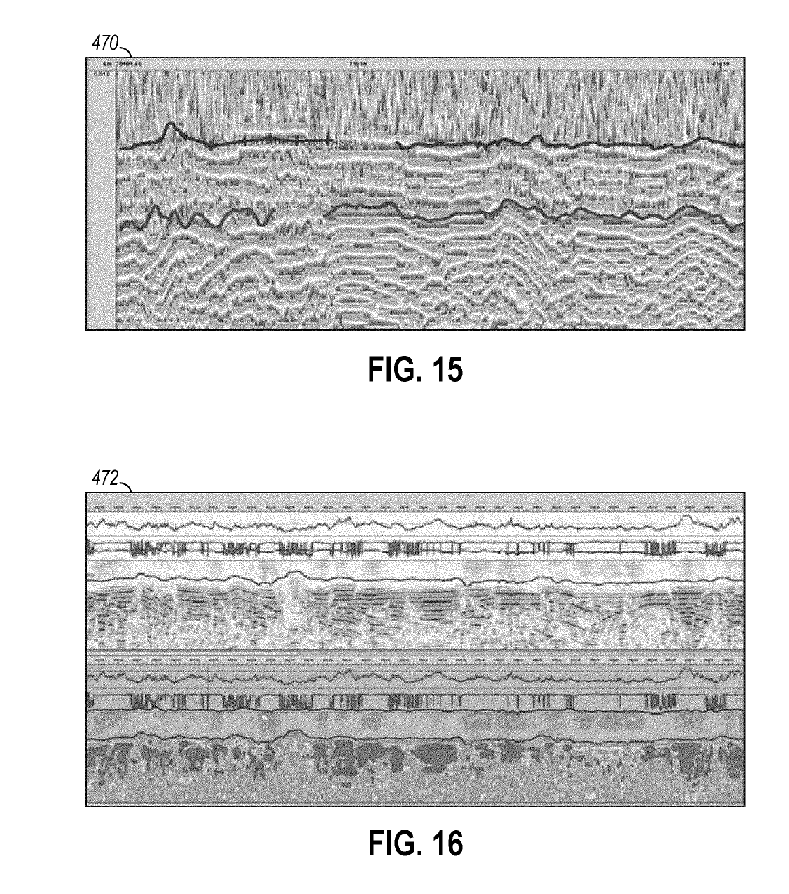

Now turning to FIGS. 15-19, these figures illustrate a number of different types of visualizations of sonic data that may be implemented within a seismic-based visualization tool after conversion of the sonic data to the seismic domain. FIGS. 15 and 16, for example, illustrate an example two dimensional visualization in a tool such as IESX Seis3DV, available from Schlumberger Ltd., after sonic data has been converted to the seismic domain, processed to fill in gaps in the data and returned to the sonic domain. FIG. 15 illustrates a visualization 470 where data is transformed into instantaneous phase to aid in re-picking, with compressional and shear information overlaid on the visualization, while FIG. 16 illustrates a visualization 472 where data is viewed in conjunction with computed horizon attributes for advanced analysis.

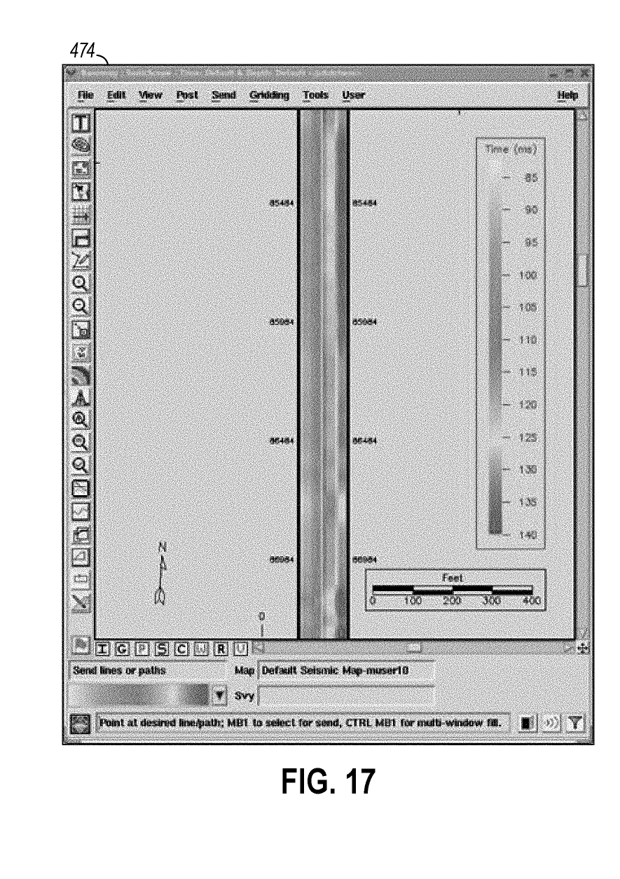

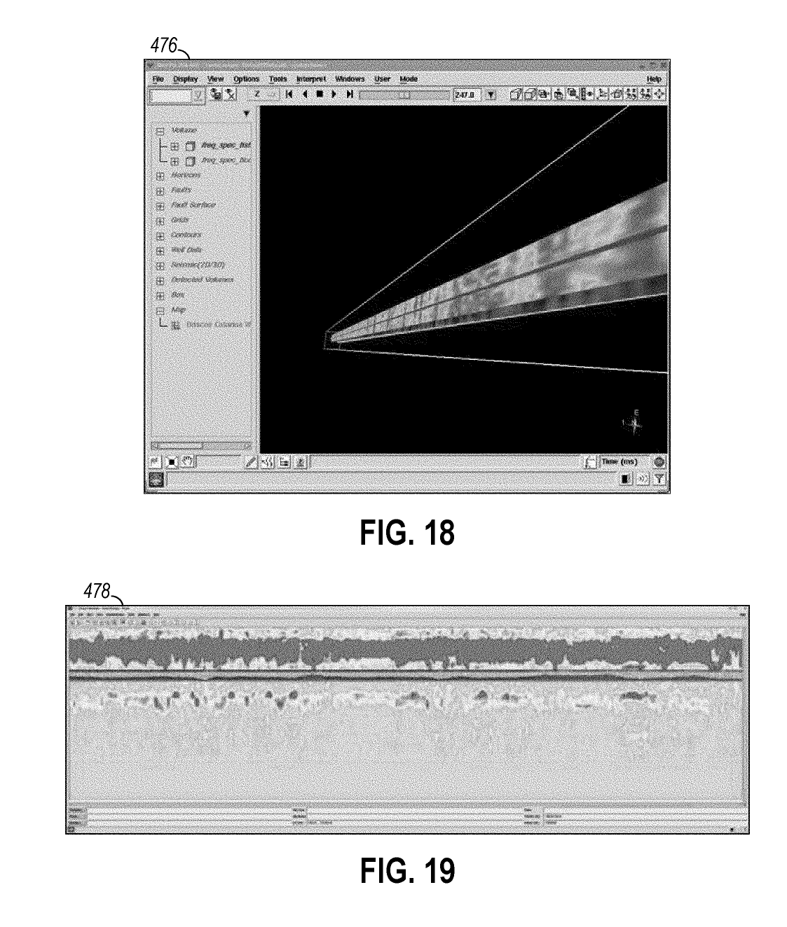

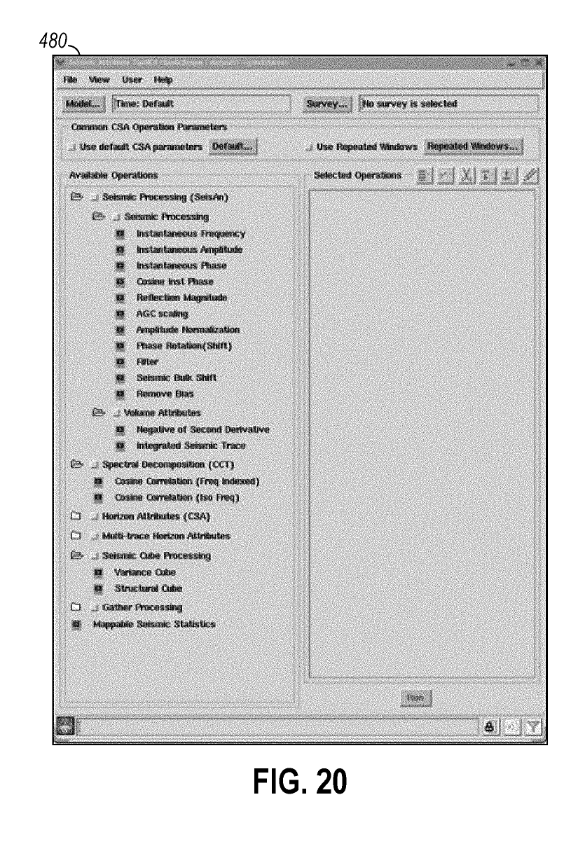

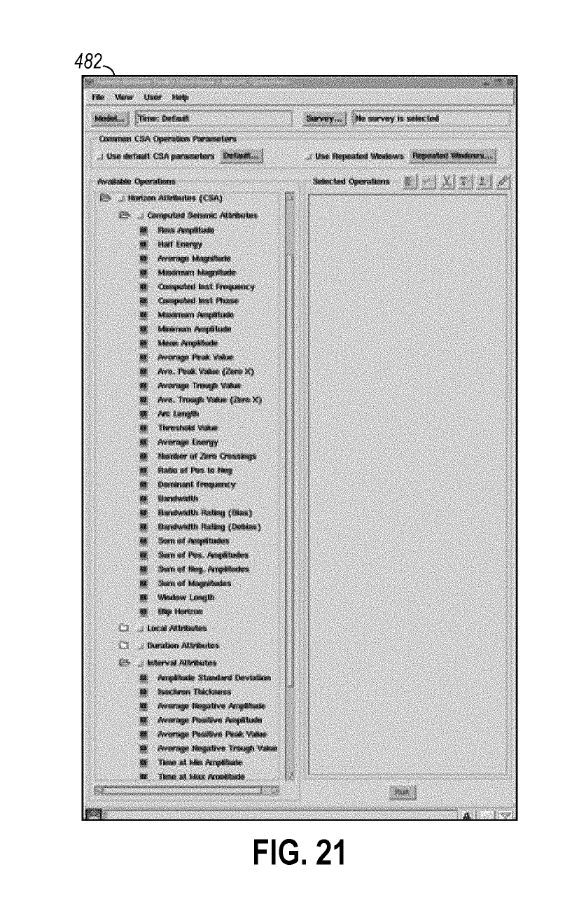

FIG. 17 illustrates an example visualization 474 of sonic data in a seismic mapping application such as the Basemap application available from Schlumberger for advanced interpretation. Similarly, FIG. 18 illustrates an example visualization 476 of sonic data in a three dimensional seismic application such as the GeoViz application available from Schlumberger Ltd. In addition, FIG. 19 illustrates an example visualization 478 of sonic data in a geology application, and shows an overlaying of petrophysical data such as from the ELAN solver available from Schlumberger Ltd. FIGS. 20 and 21 respectively illustrate attribute extraction dialog boxes 480, 482 for use in generating seismic volume (cube) attributes and horizon attributes. Suitable attributes/operations illustrated in dialog box 480, which are not the only attributes/operations that may be extracted or performed, include instantaneous frequency, instantaneous amplitude, instantaneous phase, cosine instantaneous phase, reflection magnitude, AGC scaling, amplitude normalization, phase rotation (shift), filter, seismic bulk shift, remove bias, negative of second derivative volume attributes, integrated seismic trace volume attributes, spectral decomposition (CCT), cosine correlation (frequency indexed), cosine correlation (Iso frequency), variance cube processing, structural cube processing, etc. Suitable attributes/operations illustrated in dialog box 482, which are not the only attributes/operations that may be extracted or performed, include amplitude, half energy, average magnitude, maximum magnitude, computed instantaneous frequency, computed instantaneous phase, maximum amplitude, mean amplitude, average peak value, average peak value (Zero X), average trough value, average trough value (Zero X), arc length, threshold value, average energy, number of zero crossings, ratio of positive to negative, dominant frequency, bandwidth, bandwidth rating, sum of amplitudes, sum of positive amplitudes, sum of negative amplitudes, sum of magnitudes, window length, blip horizon, as well as interval attributes such as amplitude standard deviations, isochron thickness, average negative amplitude, average positive amplitude, average positive peak value, average negative trough value, time at minimum amplitude, time at maximum amplitude, etc.

The potential applications to which the herein-described techniques can be applied are innumerable. For example, in some embodiments, a borehole image may be constructed from azimuthally varying Compressional, Shear, or Stoneley slowness measurements. Such a slowness image may allow observations of structural, rock fabric, and stress induced changes to the formation around the borehole, that were previously unavailable from conventional sonic plots.

In addition, the herein-described techniques may be used to facilitate fracture identification and/or classification, discriminating between free gas and kerogen, primary and secondary wave extraction, particularly for difficult lithologies or environments, fault identification, extracting azimuthal attributes and other attributes associated with core stress and texture, stress identification and characterization, calibration of seismic attribute clusters with core measurements for quantification, Q analysis, denoising or other data enhancements, generating envelopes, data interpolation, gas hydrate, data filtering, pore pressure prediction, thief zone delineation, completion optimization, hydro-frac evaluation, re-frac evaluation, MEM calibration, hydrocarbon identification, fault/bed boundary identification, etc. In another application, the herein-described techniques may be used to facilitate extraction of C44 slow shear for input in three dimensional TI-V geomechanical processing. The invention is therefore not limited to the particular applications discussed herein.

While particular embodiments have been described, it is not intended that the invention be limited thereto, as it is intended that the invention be as broad in scope as the art will allow and that the specification be read likewise. It will therefore be appreciated by those skilled in the art that yet other modifications could be made without deviating from its spirit and scope as claimed.

What is claimed is:

1. A method of analyzing sonic or ultrasonic waveform data, comprising:
converting waveform data in a sonic or ultrasonic frequency range to a seismic data format; and
analyzing the waveform data using a seismic-based computer program executing on at least one processor after converting the waveform data to the seismic data format.

2. The method of claim 1, wherein the seismic-based computer program comprises a seismic application, and wherein analyzing the waveform data includes processing the waveform data using the seismic application to generate result data.

3. The method of claim 2, further comprising converting the result data from a seismic data format to a sonic data format.

4. The method of claim 3, further comprising processing the result data using a sonic-based computer program after converting the result data to the sonic data format.

5. The method of claim 1, wherein the waveform data is converted from a sonic data format, the method further comprising processing the waveform data using a sonic-based computer program prior to converting the waveform data to the seismic data format.

6. The method of claim 5, wherein processing the waveform data using the sonic-based computer program includes extracting time of arrival data from the waveform data and storing the time of arrival data in a set of logs.

7. The method of claim 6, further comprising refining the time of arrival data using the seismic-based computer program.

8. The method of claim 1, wherein converting the waveform data comprises organizing the waveform data into at least one seismic volume.

9. The method of claim 8, wherein the seismic volume comprises a seismic cube.

10. The method of claim 8, wherein the seismic volume comprises a pseudo-seismic cube.

11. The method of claim 8, wherein the seismic-based computer program comprises an attribute extraction tool, and wherein analyzing the waveform data comprises extracting at least one seismic attribute from the at least one seismic volume using the attribute extraction tool.

12. The method of claim 1, wherein converting the waveform data comprises rotating the waveform data prior to storing the waveform data in the seismic data format.

13. The method of claim 12, wherein converting the waveform data further comprises adjusting a time scale of the waveform data prior to storing the waveform data in the seismic data format.

14. The method of claim 1, wherein the waveform data comprises sonic waveform data in a sonic frequency range and collected via sonic logging.

15. The method of claim 1, wherein the waveform data comprises ultrasonic waveform data in an ultrasonic frequency range and collected via ultrasonic logging.

16. The method of claim 1, wherein the waveform data is collected via wellbore logging, and wherein the seismic-based computer program is configured to operate on seismic data collected via a surface seismic survey.

17. The method of claim 1, wherein the seismic-based computer program comprises a visualization tool, and wherein analyzing the waveform data comprises displaying the waveform data using the visualization tool.

18. The method of claim 1, wherein converting the waveform data to the seismic data format masquerades the waveform data as seismic data.

19. An apparatus, comprising:
at least one processor; and
program code configured upon execution by the at least one processor to receive waveform data in a sonic or ultrasonic frequency range and convert the waveform data to a seismic data format such that the converted waveform data is in a format that is compatible with a seismic-based computer program after converting the waveform data to the seismic data format.

20. A program product, comprising:
a computer readable medium; and
program code stored on the computer readable medium and configured upon execution by at least one processor to receive waveform data in a sonic or ultrasonic frequency range and convert the waveform data to a seismic data format such that the converted waveform data is in a format that is compatible with a seismic-based computer program after converting the waveform data to the seismic data format.
